(19) United States
(12) Patent Application Publication
(10) Pub. No.: US 2006/0105305 A1
(43) Pub. Date: May 18, 2006

(54) Early speech development system

(75) Inventor: Donald J. Stewart, Heathrow, FL (US)

Correspondence Address: BEUSSE BROWNLEE WOLTER MORA & MAIRE, 390 N. ORANGE AVENUE, SUITE 2500, ORLANDO, FL, 32801, US

(73) Assignee: BABY CHATTERBOX, INC.

(21) Appl. No.: 11/272,551

(22) Filed: Nov. 10, 2005

Related U.S. Application Data
(60) Provisional application No. 60/627,419, filed on Nov. 13, 2004.

(51) Int. Cl. G09B 17/00

(52) U.S. Cl. 434/178

(57) ABSTRACT

Disclosed herein is a early speech development system. In a typical embodiment, the system comprises a visual output device 150 comprising a surface area 155 for exhibiting visual images; an auditory output device 140 designed for producing auditory sounds; a storage medium 130 onto which a presentation is stored and a processing device 160 for transducing information on said storage medium 130 into signals to be sent to said visual output device 150 and said auditory output device 140. The presentation comprises a first auditory output of background music and sounds to amuse an infant; a first visual output of images depicting an object or action to which a word to be said by said infant pertains; a second auditory output of sounds representing a verbal pronouncement of said word; and a second visual output of images depicting a person pronouncing said word simultaneous to a third auditory output of sounds representing a verbal pronouncement of said word, wherein the face of said person pronouncing said word occupies at least twenty percent of said surface area of said visual output device.

### CROSS-REFERENCE TO RELATED APPLICATIONS

This application claims priority to U.S. Serial No. 60/627,419 filed Nov. 13, 2004, which is hereby incorporated in its entirety.

### FIELD OF INVENTION

This invention relates to a system for assisting speech development. The system may be used to for early speech development in infants, learning a foreign language or for speech therapy for individuals with a speech problem. The system is particularly adaptable for encouraging speech development in infants.

### DESCRIPTION OF RELATED ART

The world of a newborn is a tangle of strange new sights and sounds which the infant must sort through and organize into an orderly arrangement of information. This process occurs during the normal course of the baby's development as she explores her environment and tests the world around her. These early interactions between the infant and her surroundings encourage neural growth and stimulate mental development.

Early speech development systems that are currently commercially available do serve some benefit in stimulating infants through the use of auditory sounds and visual images. One system in particular, Bee Smart Baby (BabyBumbleBee, Crystal City, Fla.), provides visual images of objects with auditory sound pertaining to verbal pronouncement of the objects. However, this system and other current speech development systems have not yet recognized and implemented one of the most powerful influences of learning and development in infants: the desire and natural tendency to emulate other people. The mere sounding of words pertaining to an object do not assist an infant with movements of the mouth, lips and tongue associated with pronouncing the words. What is needed in the art is a speech development system that harnesses this natural tendency in infants to assist and encourage early speech development in infants.

### BRIEF DESCRIPTION OF DRAWINGS

FIG. 1 shows a diagram of an embodiment of an early speech development system according to the subject invention.

FIG. 2 shows a flow diagram of a method embodiment of the subject invention.

FIG. 3 shows a flow diagram of a method embodiment of the subject invention.

### DETAILED DESCRIPTION

The subject invention pertains to an early speech development system, methods, and related materials that implement visual images, auditory sounds, representing an object or action of a word to be learned combined with a visual representation of a person pronouncing the word. The visual images produced by the subject system are exhibited from a visual output device designed for exhibiting images. Because the visual stimulation of someone pronouncing a given word will dramatically stimulate the proper facial, mouth, teeth and tongue movements, which will accelerate the mastery of learning to speak the word, the subject invention in typical embodiments showcases the visual representation of a person pronouncing the word by provision of a close-up images of the person's face while pronouncing the word. Typically, this involves designing the visual images such that the person's face occupies fifteen percent or more of the surface area of the visual output device while pronouncing the word to be learned. In a preferred embodiment, the visual representation of pronouncing the word is repeated two or more times.

The visual output device may be any type of device comprising a screen, wherein the device is designed for receiving electrical signals and transducing those signals into visual images displayed on the screen. Visual output devices may include, but are not limited to, televisions, computer monitors, and the like which implement cathode-ray-diode screens, plasma screens, LCD screens, projection screens and the like.

The auditory output of sounds presented by the subject invention may be provided by any appropriate device designed for receiving signals and transducing those signals into discernible auditory sound. Typically, the auditory output device is one or more speakers. The auditory device may be structurally attached to the visual output device or provided as a separate unit.

In a specific system embodiment of the subject invention, visual images and auditory sounds are stored on a suitable storage medium that can be read by a processing device, which converts the information on the storage medium into signals to be sent to a visual output device and auditory output device. The storage medium may include, but is not limited to, a CD, DVD, videotape, hard drive, or multimedia disc, and the like. The processing device may include, but is not limited to, a CD player, a DVD player, a videotape player, a personal computer or other type of computer that is able to process information into signals.

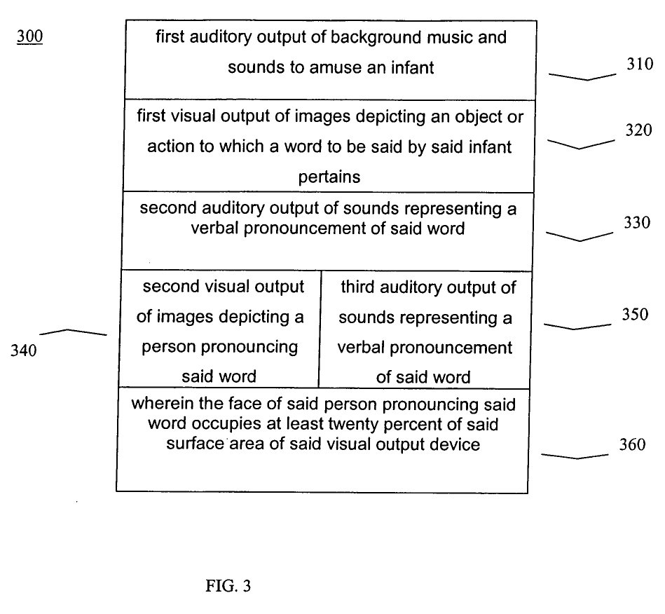

Stored on the storage medium is information pertaining to a presentation of organized visual images and auditory sounds. In a specific embodiment, as shown in FIG. 3, the presentation 300 comprises a first auditory output of background music and sounds to amuse an infant 310. Typically, this would include playful music and sounds designed for capturing an infant's attention. The presentation further includes, a first visual output of images depicting an object or action to which a word to be said by said infant pertains 320; a second auditory output of sounds representing a verbal pronouncement of the word 330; and a second visual output of images depicting a person pronouncing the word 340 simultaneous to a third auditory output of sounds representing a verbal pronouncement of said word 350. The presentation provides for the face of the person pronouncing the word to occupy at least twenty percent of a surface area of a visual output device which is exhibiting the visual images of the presentation. In a preferred embodiment the face of the person saying the word occupies at least 30 percent of the surface area of the visual output device. Preferably still, the face of the person saying the word occupies at least 40 percent of the surface area of the visual output device.

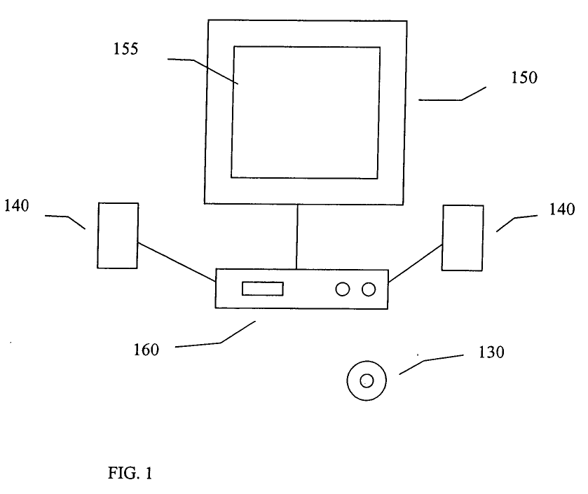

In a specific embodiment of the subject invention pertaining to a system, shown in FIG. 1, the system 100 comprises a visual output device 150 comprising a surface area 155 for exhibiting visual images. Attached to or separate from said visual output device 150 is an auditory output device 140 designed for producing auditory sounds. The system 100 comprises a processing device 160. The processing device 160 converts information stored on a storage medium 130 into signals to be sent to the visual output device 150 and said auditory output device 140. The information stored on the storage medium 130 is the presentation provided in FIG. 3 as discussed above.

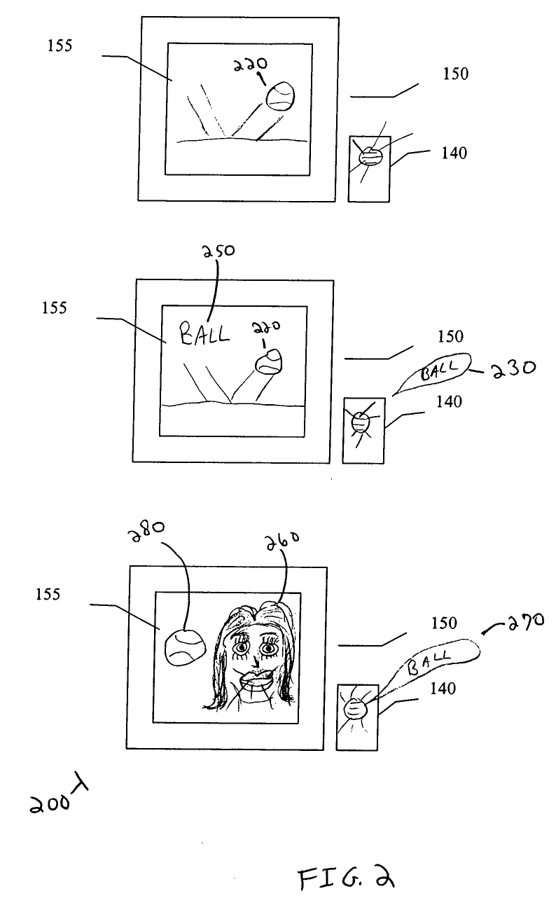

In a method embodiment of the subject invention, as shown in FIG. 2, the method 200 encourages early speech development in infants by the following steps. A series of images depicting an object or action to which a word pertains is presented 210 to an infant via a visual output device 150 comprising a surface 155 for exhibiting images. As shown in FIG. 2, visual images of a ball 220 is presented. A series of sounds representing a verbal pronouncement of the word ball 230 is presented to an infant via an auditory output device 140 while showing a visual image of the ball 220. Alternatively, to assist in early reading development, the word BALL 250 is provided on the screen 155. Critical to this method embodiment for maximizing early speech development, the method 200 involves presenting to the infant via said visual output device 150 a second series of images depicting a face of a person pronouncing said word 260 simultaneous to a third series of sounds representing a verbal pronouncement of said word 270. As shown in FIG. 2 the face of the person 260 occupies at least forty percent of the surface area of the screen 155. This close-up of the person 260 stimulates the infant to produce the proper oratory movements of the mouth, teeth, lips and tongue. Also, in a preferred embodiment, visual images of the ball 280 are present on the screen while the person is pronouncing the word.

It should be noted that in accordance with conventional patent claim construction, use of the terms first, second, third, etc., unless stated otherwise, does not refer to an order or temporal sequence, but is used simply delineate a given limitation from another limitation.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims. The teachings of all patents and other references cited herein are incorporated herein by reference to the extent they are not inconsistent with the teachings herein.

What is claimed is:

1. An early speech development system for infants comprising:
a visual output device comprising a surface area for exhibiting visual images;
an auditory output device designed for producing auditory sounds;
a storage medium onto which a presentation is stored, said presentation comprising
(i) a first auditory output of background music and sounds to amuse an infant;
(ii) a first visual output of images depicting an object or action to which a word to be said by said infant pertains;
(iii) a second auditory output of sounds representing a verbal pronouncement of said word; and
(iv) a second visual output of images depicting a person pronouncing said word in coordination with a third auditory output of sounds representing a verbal pronouncement of said word, wherein the face of said person pronouncing said word occupies at least twenty percent of said surface area of said visual output device; and
a processing device for transducing information on said storage medium into signals to be sent to said visual output device and said auditory output device.

2. The system of claim 1, wherein the face of said person pronouncing said word occupies at least thirty percent of said surface area of said visual output device.

3. The system of claim 2, wherein the face of said person pronouncing said word occupies at least forty percent of said surface area of said visual output device.

4. The system of claim 3, wherein the face of said person pronouncing said word occupies at least fifty percent of said surface area of said visual output device.

5. The system of claim 1, wherein said output device is a screen.

6. The system of claim 1, wherein said output device is a cathode-ray-diode screen, plasma screen, LCD screen, projection screen.

7. The system of claim 1, wherein said storage medium is a CD, DVD, videotape, hard drive, or multimedia disc.

8. The system of claim 1, wherein said processing device is a device configured for processing information stored on a CD, DVD, videotape, hard drive or multimedia disc to produce signals to be sent to said visual output device and said auditory device for transduction into visual output and auditory output, respectively.

9. The system of claim 8, wherein said processing device is a DVD player.

10. The system of claim 1, wherein said auditory output device is a speaker.

11. The system of claim 1, wherein said first and second visual output of images coincidentally occupy said surface area of said visual output device.

12. The system of claim 1, wherein said visual output device, auditory output device and processing device are housed within a casing to provide a single unit.

13. The system of claim 12, wherein said single unit is configured into the shape of a box comprising a screen pivotably engaged to a portion of said box perimeter.

14. The system of claim 12, wherein said single unit is configured into a shape or object amusing to an infant.

15. A storage medium onto which a presentation is stored, said presentation designed for encouraging speech development via presenting auditory and visual information to be outputted by a visual output device and a auditory output device, wherein said presentation comprises
(i) a first auditory output of background music and sounds to amuse an infant;
(ii) a first visual output of images depicting an object or action to which a word to be said by said infant pertains;
(iii) a second auditory output of sounds representing a verbal pronouncement of said word; and
(iv) a second visual output of images depicting a person pronouncing said word in coordination with a third auditory output of sounds representing a verbal pronouncement of said word, wherein the face of said person pronouncing said word occupies at least twenty percent of said surface area of said visual output device.

16. A method for encouraging early speech development in infants comprising:
(a) presenting to an infant via an auditory output devices designed for producing sound a first series of sounds pertaining to music and sounds designed for amusing said infant;
(b) presenting to said infant via a visual output device comprising a surface for exhibiting images a first series of images depicting an object or action to which a word to be said by said infant pertains;
(c) presenting to said infant via said auditory output device a second series of sounds representing a verbal pronouncement of said word; and
(d) presenting to said infant via said visual output device a second series of images depicting a face of a person pronouncing said word in coordination with a third series of sounds representing a verbal pronouncement of said word, wherein the face of said person pronouncing said word occupies at least twenty percent of said surface area of said visual output device.

17. The method of claim 16, wherein at least one of said steps (b)-(d) are repeated at least once for said word.

18. The system of claim 1, further comprising a third visual output of images depicting said object or action to which said word pertains occupies said surface area concurrently with said second visual output of images.

19. The system of claim 1 wherein said presentation successively repeats outputs of (ii)-(iv) for a series of different words to be said by said infant.

20. A method for encouraging early speech development in infants comprising:
(a) presenting to an infant via an auditory output devices designed for producing sound a first series of sounds pertaining to music and sounds designed for amusing said infant;
(b) presenting to said infant via a visual output device comprising a surface for exhibiting images a first series of images depicting an object or action to which a word to be said by said infant pertains;
(c) presenting to said infant via said auditory output device a second series of sounds representing a verbal pronouncement of said word; and
(d) presenting to said infant via said visual output device a second series of images depicting a face of a person pronouncing said word and a third series of images depicting an object or action to which said word pertains, wherein said second and third series of images simultaneously occupy a portion of said surface area of said visual output device; and
(e) presenting to said infant via said auditory output device a third series of sounds representing a verbal pronouncement of said word, said third series of sound presented to coordinate with said second series of images.
